(19) United States
(12) Patent Application Publication
(10) Pub. No.: US 2013/0154505 A1
(43) Pub. Date: Jun. 20, 2013

(54) KEYPAD ASSEMBLY

(71) Applicants: Guan-Nan REN, Shenzhen City (CN); Wei PANG, Shenzhen City (CN)

(72) Inventors: Guan-Nan REN, Shenzhen City (CN); Wei PANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/486,568

(22) Filed: Jun. 1, 2012

(30) Foreign Application Priority Data
Dec. 17, 2011 (CN) 201110423662.6

(51) Int. Cl. H05B 37/02

(52) U.S. Cl. 315/294; 315/312

(57) ABSTRACT

A keypad assembly includes a panel, a plurality of keys protruding from the panel, a light-emitting assembly, and a control unit. The light-emitting assembly includes a cover board and a plurality of light-emitting members mounted on the cover board. The cover board is hinged to the panel such that the cover board is capable of rotating relative to the panel to enable the light-emitting members to illuminate the keys. The control unit includes an angle sensor and a controller. The angle sensor senses an included angle between the cover board and the panel and creates signals of the included angle. The controller receives the signals and accordingly controls the light-emitting members to be turned on or turned off.

### BACKGROUND

1. Technical Field

The present disclosure generally relates to a keypad assembly.

2. Description of Related Art

Users must sometimes use computers under dark conditions. Typing Errors are easily made under dark conditions.

Therefore, there is room for improvement within the art.

### BRIEF DESCRIPTION OF THE DRAWINGS

Many aspects of the disclosed keypad assembly can be better understood with reference to the following drawings. The components in the drawings are not necessarily drawn to scale, the emphasis instead being placed upon clearly illustrating the principles of the present keypad assembly.

FIG. 1 is an isometric view of a keypad assembly in accordance with an exemplary embodiment.

FIG. 2 is a partially disassembled perspective view of the keypad assembly of FIG. 1.

FIG. 3 is an enlarged view of a circled portion III of FIG. 2.

FIG. 4 is a functional block diagram of a control unit of a keypad assembly in accordance with an exemplary embodiment.

### DETAILED DESCRIPTION

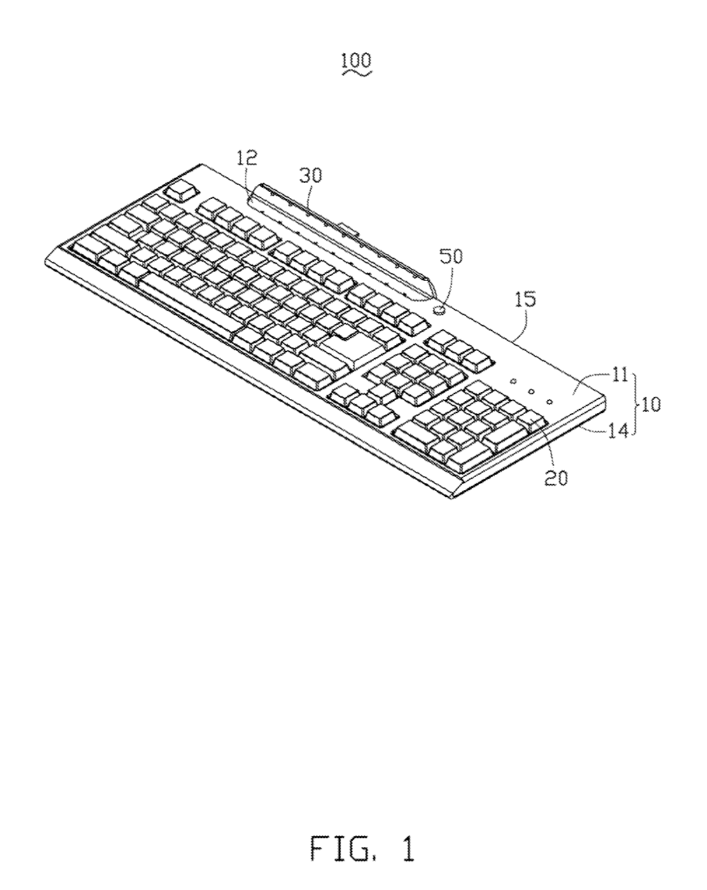

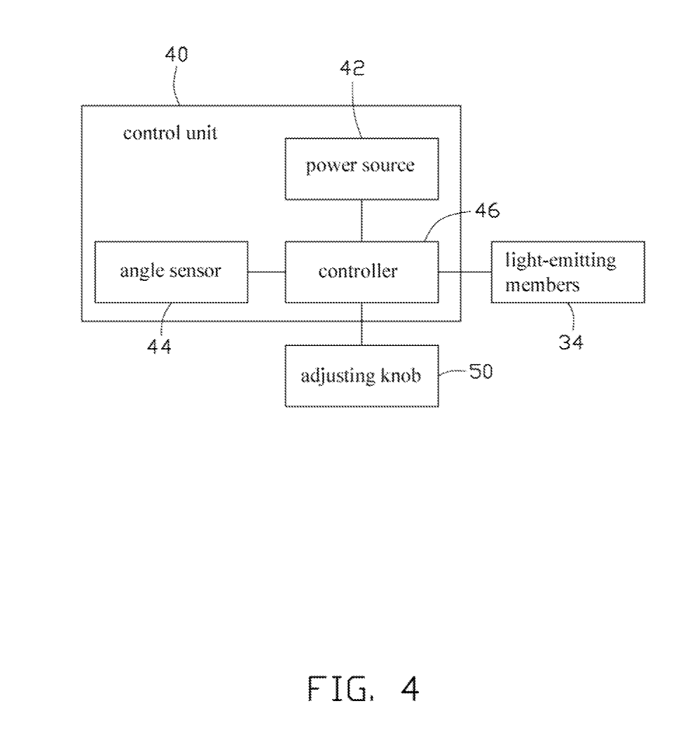

FIG. 1 shows an exemplary embodiment of a keypad assembly 100. The keypad assembly 100 includes a panel 10, a plurality of keys 20, a light-emitting assembly 30, a control unit 40 (see FIG. 4), and an adjusting knob 50. The keys 20, the light-emitting assembly 30, and the adjusting knob 50 are mounted on the panel 10. The disclosed keypad assembly may be applied in computers.

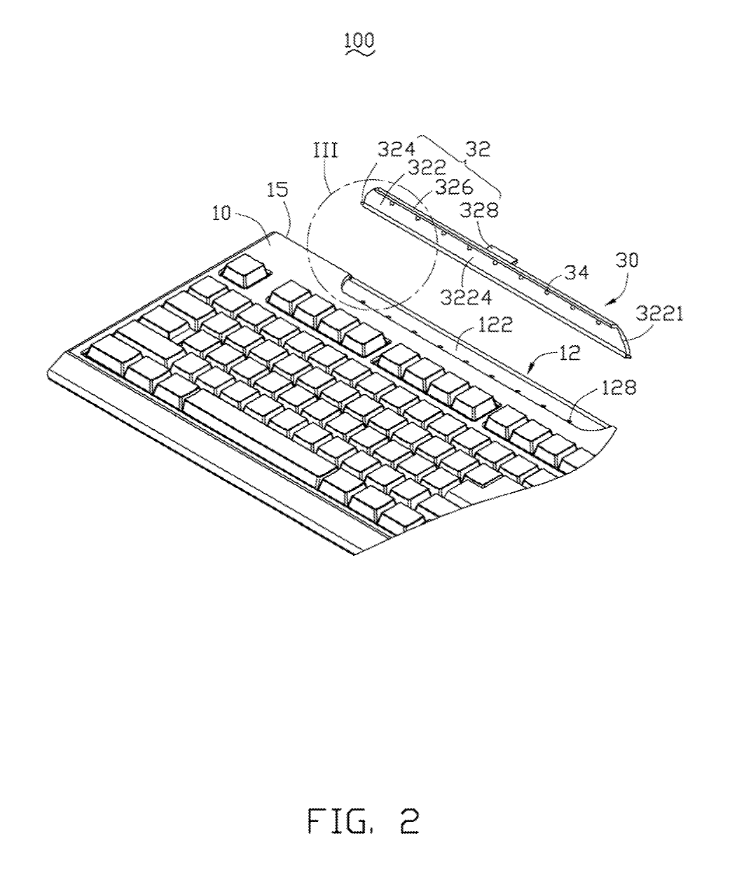

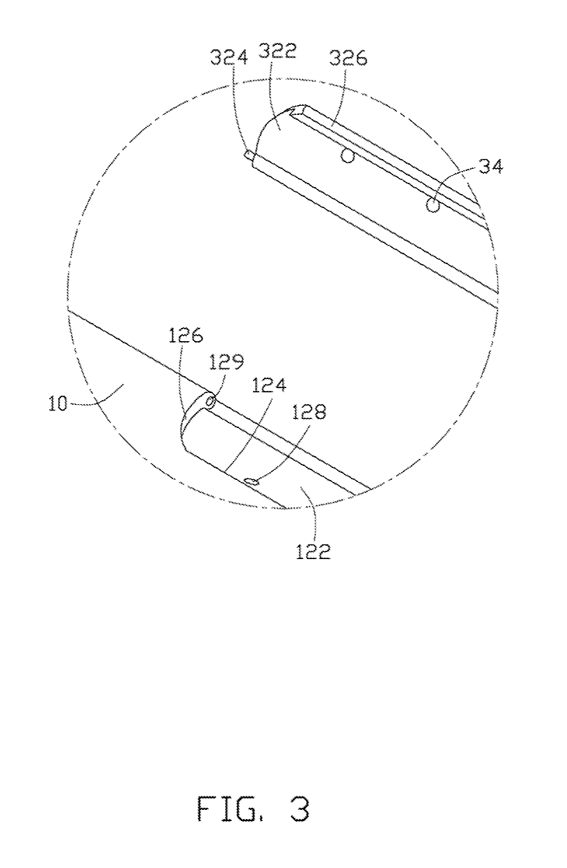

Referring to FIGS. 2 and 3, the panel 10 includes a first surface 11 and a second surface 14 opposite to the first surface 11. The keys 20 protrude from the first surface 11. Data (in the form of characters, numbers, symbols and other) can be input into a terminal device using the keypad assembly 100 by the keys 20. The first surface 11 defines a receiving recess 12 at an edge 15 of the panel 10 for receiving the light-emitting assembly 30. The receiving recess 12 includes a bottom wall 122, a side wall 124, and two end walls 126. The bottom wall 122 defines a plurality of receiving holes 128 arranged substantially in a line. The two end walls 126 are connected with two opposite ends of the side wall 124. In the exemplary embodiment, each end wall 126 is arcuate and defines a pivot hole 129 in an end away from the side wall 124. The two pivot holes 129 in the two end walls 126 are coaxial with each other.

The light-emitting assembly 30 is pivotally received in the receiving recess 12. The light-emitting assembly 30 includes a cover board 32 and a plurality of light-emitting members 34 mounted on the cover board 32. The cover board 32 includes a main portion 322, two axles 324, a bent portion 326, and a handle 328. Each axle 324 protrudes from an end 3221 of the main portion 322. The cover board 32 is hinged to the panel 10 with the two axles 324 rotatably received in the two pivot holes 129. The bent portion 326 extends away from the main portion 322 and bends towards the panel 10. The handle 328 is formed on and protrudes from the main portion 322. Users can utilize the handle 328 to rotate the cover board 32.

In the exemplary embodiment, each light-emitting member 34 is a light emitting diode (LED). The light-emitting members 34 are separately secured on a surface 3224 of the main portion 322 facing the panel 10 when the cover board 32 is received in the receiving recess 12. When the light-emitting assembly 30 is received in the receiving recess 12, each lighting member 34 is received in a corresponding receiving hole 128 to allow the cover board 32 to be flush with the panel 10. When the light-emitting assembly 30 is rotated out of the receiving recess 12, the light-emitting members 34 are lighted and illuminate the keys 20. Accordingly, users can use the keypad assembly 100 under dark conditions. Furthermore, the bent portion 326 may be made of a material or have a shape that reflect light from the light-emitting members 34 onto the keys 20, improving the effectiveness of the light-emitting members 34.

Referring to FIG. 4, the control unit 40 controls the light-emitting members 34 to be turned on or turned off according to an included angle between the cover board 32 and the panel 10. Specifically, the control unit 40 includes a power source 42, an angle sensor 44, and a controller 46. The power source 42 can be a 5 volt power source of a terminal device, such as a personal computer. The power source 42 electrically connects with the controller 46 and provides an operating voltage for the controller 46. The angle sensor 44 electrically connects with the controller 46. The angle sensor 44 is received in a pivot hole 129 close to an axle 324. The angle sensor 44 senses the included angle between the cover board 32 and the panel 10, and creates and sends signals of the included angle to the controller 46. The controller 46 electrically connects with the light-emitting members 34. The controller 46 receives the angle signals and transforms the angle signals into a numeral value. The controller 46 compares the numeral value with a preset angle range (such as an angle range from 30° to 110°), and controls the light-emitting members 34 to be turned on or turned off according to the result of the comparison. If the numeral value is within the preset angle range, the controller 46 may send a first signal (such as logic “1”) to the light-emitting members 34 to control the light-emitting members 34 to be turned on. If the numeral value is outside of the preset angle range, the controller 46 may send a second signal (such as logic “0”) to the light-emitting members 34 to control the light-emitting members 34 to be turned off.

The adjusting knob 50 is secured on the panel 10 and electrically connects with the controller 46. The adjusting knob 50 is used to adjust the amount of current provided by the controller 46 for the light-emitting members 34, thereby adjusting the brightness of light emitted by the light-emitting members 34 to meet the requirements of different light conditions.

When users operate the keypad assembly 100 under dark conditions, the cover board 32 can be rotated out of the receiving recess 12 by using a fingertip on the handle 328. The angle sensor 44 senses the included angle between the cover board 32 and the panel 10, and sends signals of the included angle to the controller 46. The controller 46 transforms the signals into a numeral value and compares the numeral value with the preset angle range. If the numeral value is within the preset angle range, the controller 46 may order the light-emitting members 34 to be lighted. The light-emitting members 34 can be turned off by closing the cover board 32.

It is to be understood, however, that even through numerous characteristics and advantages of the present disclosure have been set forth in the foregoing description, together with details of assembly and function, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A keypad assembly comprising:
a panel;
a plurality of keys protruding from the panel;
a light-emitting assembly comprising a cover board and a plurality of light-emitting members mounted on the cover board, the cover board hinged to the panel such that the cover board is capable of rotating relative to the panel to enable the light-emitting members to illuminate the keys;
a control unit comprising an angle sensor and a controller electrically connected with the angle sensor, the angle sensor sensing an included angle between the cover board and the panel and creating angle signals, the controller receiving the angle signals and accordingly controlling the light-emitting members to be turned on or turned off depending on the angle signal.

2. The keypad assembly as claimed in claim 1, wherein the controller transforms the angle signals into a numeral value and compares the numeral value with a preset angle range; when the numeral value is within the preset angle range, the controller sends a first signal to the light-emitting members, controlling the light-emitting members to be lighted; when the numeral value is outside of the preset angle range, the controller sends a second signal to the light-emitting members, controlling the light-emitting members to be turned off.

3. The keypad assembly as claimed in claim 1, wherein the panel defines a receiving recess; the cover board is pivotally received in the receiving recess.

4. The keypad assembly as claimed in claim 3, wherein the receiving recess includes a bottom wall; the bottom wall defines a plurality of receiving holes, the receiving holes receive the light-emitting members when the cover board received in the receiving holes.

5. The keypad assembly as claimed in claim 3, wherein the receiving recess includes two end walls, each end wall defines a pivot hole; the cover board includes a main portion and two axles, the two axles protrude from two ends of the main portion and rotatably received in the pivot holes respectively.

6. The keypad assembly as claimed in claim 5, wherein the cover board further includes a bent portion extending away from the main portion and bending towards the panel.

7. The keypad assembly as claimed in claim 6, wherein the bent portion is made of a material that reflects light from the light-emitting members onto the keys.

8. The keypad assembly as claimed in claim 6, wherein the bent portion is shaped to reflect light from the light-emitting members onto the keys.

9. The keypad assembly as claimed in claim 5, wherein the cover board further includes a handle formed on and protruding from the main portion.

10. The keypad assembly as claimed in claim 5, wherein the light-emitting members are secured on a surface of the main portion facing the panel when the cover board is received in the receiving recess.

11. The keypad assembly as claimed in claim 1, further comprising an adjusting knob, wherein the adjusting knob is secured on the panel and electrically connects with the controller for adjusting the brightness of light emitted by the light-emitting members.

12. The keypad assembly as claimed in claim 1, wherein each of the light-emitting members is a LED.

13. The keypad assembly as claimed in claim 1, wherein the control unit further includes a power source, the power source electrically connects with the controller, providing an operating voltage for the controller.
